(19) United States
(12) Patent Application Publication
(10) Pub. No.: US 2026/0316297 A1
(43) Pub. Date: Oct. 15, 2026

(54) FINGER SUBASSEMBLY FOR A ROBOTIC MANIPULATOR

(71) Applicant: Ocado Innovation Limited, Hatfield (GB)

(72) Inventors: Jan FRAS, Kornik (PL); Panagiotis SOTIROPOULOS, London (GB); Hussein MNYUSIWALLA, London (GB); Enrique DEL SOL ACERO, London (GB)

(21) Appl. No.: 19/104,139

(22) PCT Filed: Aug. 10, 2023
(86) PCT No.: PCT/EP2023/072244

§ 371 Date: Feb. 14, 2025

(30) Foreign Application Priority Data
Aug. 18, 2022 (GB) 2212045.5

(51) Int. Cl. B25J 15/06; B25J 15/00

(52) U.S. Cl. CPC B25J 15/0625; B25J 15/0023

(57) ABSTRACT

The present disclosure relates to a finger subassembly (12) for a manipulator apparatus. The finger subassembly comprises a rigid body (13) having an aperture and an inflatable element (36) received within the rigid body. A pressure chamber (37) is formed within the inflatable element. The pressure chamber is connectable to a pressure source (18′) and comprises a section configured to cause a region of the inflatable element to form a protrusion (41) extending through the aperture when the pressure chamber is pressurised. The protrusion is arranged to define a suction chamber (44). The inflatable element further comprises a channel (22) extending between the region of the inflatable element that forms the protrusion when the pressure chamber is pressurised and a vacuum source (20′) to provide a vacuum pressure at the suction chamber.

The present disclosure relates to a finger subassembly for a gripper assembly, of the type used with a robotic manipulator. Aspects of the invention relate to the finger subassembly, the gripper assembly and the robotic manipulator.

### BACKGROUND

Automated picking systems require robotic picking stations which are able to select an item from a first receptacle, such as a tote or other storage unit, grip the item, and then move the item into a second receptacle, such as a bag. When manipulating items, it is beneficial for the finger assemblies of the manipulating apparatus to have a low friction when manoeuvring the finger assembly into contact such that the item can be grasped. However, when gripping the item, for example in order to lift it, it is beneficial for the finger assembly to have a high friction.

It is against this background that the invention was devised.

### SUMMARY

Accordingly, there is provided, in one aspect, a finger subassembly for a manipulator apparatus, the finger subassembly comprising a rigid body comprising a surface configured to engage an object to be manipulated, the surface comprising an aperture, an inflatable element received within the rigid body, a pressure chamber formed within the inflatable element, the pressure chamber being connectable to a pressure source and comprising a section configured to cause a region of the inflatable element to form a protrusion extending through the aperture when the pressure chamber is pressurised, wherein the protrusion is arranged to define a suction chamber; and, a channel formed within the inflatable element, the channel being configured to extend between the region of the inflatable element that forms the protrusion when the pressure chamber is pressurised and a vacuum source to provide a vacuum pressure at the suction chamber.

Optionally, the inflatable element further comprises a substantially planar structure extending over the region of the inflatable element configured to form the protrusion, wherein the planar structure is configured to form a sealing lip for the suction chamber when the pressure chamber is pressurised.

Optionally, the section of the pressure chamber configured to cause the region of the inflatable element to form the protrusion is positioned within a boundary defined by the aperture.

Optionally, the channel formed within the inflatable element connectable to the vacuum source comprises a pressure release valve.

Optionally, the pressure chamber is configured such that the protrusion is ring-shaped and the suction chamber defines a conical frustum.

Optionally, the surface of the rigid body further comprises a second aperture and the pressure chamber comprises a second section configured to cause a second region of the inflatable element to form a second protrusion extending through the second aperture when pressurised.

Optionally, the first and second sections of the pressure chamber are fluidically linked by a pressure line.

Optionally, the surface has a first coefficient of friction and the inflatable element has a second coefficient of friction which is greater than the first coefficient of friction.

Optionally, the inflatable element comprises a mesh. The mesh may be formed on the region of the inflatable element configured to form the protrusion.

In another aspect, there is provided a manipulator apparatus comprising a finger subassembly according to any preceding claim.

In yet another aspect, there is provided a picking system comprising the manipulator apparatus according to the previous aspect.

### BRIEF DESCRIPTION OF THE DRAWINGS

These and other aspects of the invention will now be described, by way of example only, with reference to the accompanying drawings, in which:

FIG. 1 is a schematic depiction of a picking system for use with the invention;

FIG. 2 is a schematic depiction of a gripper assembly for use with the system of FIG. 1;

FIG. 3 is a schematic depiction of a perspective view of a finger subassembly for use with the gripper assembly of FIG. 2;

FIGS. 4a and 4b show cross-sectional views of the finger subassembly of FIG. 3 taken along lines A-A (shown in FIG. 3) and B-B (shown in FIG. 4a), respectively;

FIGS. 5a and 5b show cross-sectional views of the finger subassembly of FIG. 3 with the inflatable element in an inflated state and with the application of a vacuum pressure; and,

FIGS. 6a and 6b show cross-sectional views of a second embodiment of the finger subassembly with the inflatable element in an inflated state and with the application of a vacuum pressure.

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

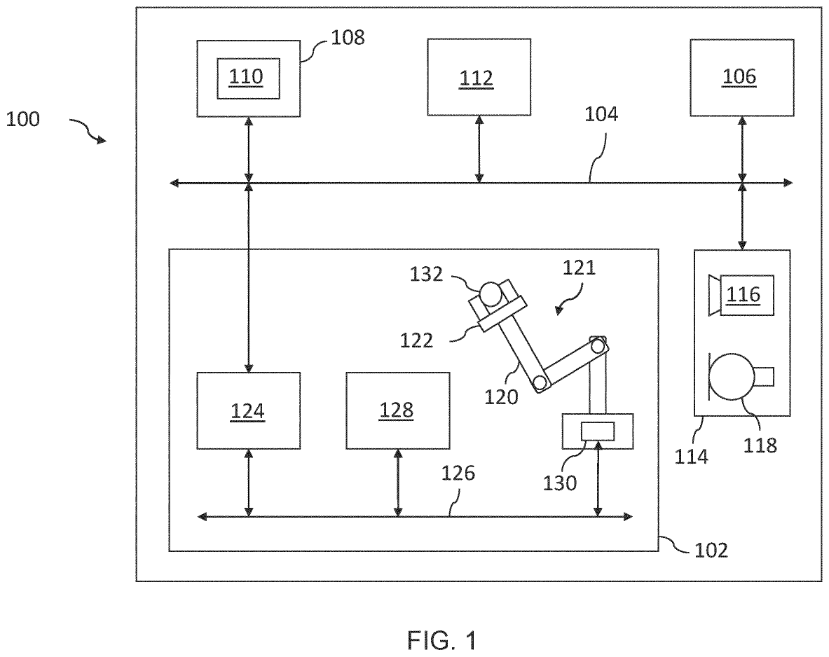

With reference to FIG. 1, there is illustrated an example of a picking system 100 of the sort that is appropriate for use with the present invention. The picking system 100 may form part of an online retail operation, such as an online grocery retail operation, but may also be applied to any other operation requiring the picking and/or sorting of items or articles. In this example, the system 100 includes a manipulator apparatus 102 comprising a robotic manipulator 121 configured to pick an article 132 from a first location and place the article 132 in a second location. The manipulator apparatus 102 is communicably coupled via a communication interface 104 to other components of the system 100, such as to one or more optional operator interfaces 106, from which an observer may observe or monitor the operation of the system 100 and the manipulator apparatus 102. The operator interfaces 106 may include a WIMP interface and an output display of explanatory text or a dynamic representation of the manipulator apparatus 102 in a context or scenario. For example, the dynamic representation of the manipulator apparatus 102 may include video and audio feed, for instance a computer-generated animation. Examples of suitable communication interface 104 include a wire based network or communication interface, optical based network or communication interface, wireless network or communication interface, or a combination of wired, optical, and/or wireless networks or communication interfaces.

The system 100 further comprises a control system 108 including at least one controller 110 communicably coupled to the manipulator apparatus 102 and the other components of the system 100 via the communication interface 104. The controller 110 comprises a control unit or computational device having one or more electronic processors, within which is embedded a set of control instructions provided as processor-executable data that, when executed, cause the controller 110 to issue actuation commands and other control signals to the manipulator system 102, causing the manipulator 121 to carry out various actions, e.g., identify and manipulate articles 132. The one or more electronic processors may include at least one logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), or the like. In some implementations, the controller 110 is a smaller processor-based device like a mobile phone, single board computer, embedded computer, or the like, which may be termed or referred to interchangeably as a computer, server, or an analyser. The set of control instructions may also be provided as processor-executable data associated with the operation of the system 100 and manipulator apparatus 102 included in a non-transitory processor-readable storage device 112, which forms part of the system 100 and is accessible to the controller 110 via the communication interface 104. In some implementations, storage device 112 includes two or more distinct devices. The storage device 112 can, for example, include one or more volatile storage devices, for instance random access memory (RAM), and one or more non-volatile storage devices, for instance read only memory (ROM), flash memory, magnetic hard disk (HDD), optical disk, solid state disk (SSD), or the like. A person of skill in the art will appreciate storage may be implemented in a variety of ways such as a read only memory (ROM), random access memory (RAM), hard disk drive (HDD), network drive, flash memory, digital versatile disk (DVD), any other forms of computer-and processor-readable memory or storage medium, and/or a combination thereof. Storage can be read only or read-write as needed.

The system 100 includes a sensor subsystem 114 comprising one or more sensors that detect, sense, or measure conditions or states of manipulator apparatus 102 and/or conditions in the environment or workspace in which the manipulator 121 operates, and produce or provide corresponding sensor data or information. Sensor information includes environmental sensor information, representative of environmental conditions within the workspace of the manipulator 121, as well as information representative of condition or state of the manipulator apparatus 102, including the various subsystems and components thereof, and characteristics of the articles 132 to be manipulated. The acquired data may be transmitted via the communication interface 104 to the controller 110 for directing the manipulator 121 accordingly. Such information can, for example, include diagnostic sensor information that is useful in diagnosing a condition or state of the manipulator apparatus 102 or the environment in which manipulator 121 operates. For example, such sensors may include contact sensors, force sensors, strain gages, vibration sensors, position sensors, attitude sensors, accelerometers, and the like. Such sensors may include one or more of cameras or optical sensors 116 (e.g., responsive in visible and/or nonvisible ranges of the electromagnetic spectrum including for instance infrared and ultraviolet), radars, sonars, touch sensors, pressure sensors, load cells, microphones 118, meteorological sensors, chemical sensors, or the like. In some implementations, the diagnostic sensors include sensors to monitor a condition and/or health of an on-board power source within the manipulator apparatus 102 (e.g., battery array, ultra-capacitor array, fuel cell array). In some implementations, the one or more sensors comprise receivers to receive position and/or orientation information concerning the manipulator 121. For example, a global position system (GPS) receiver to receive GPS data, two more time signals for the controller 110 to create a position measurement based on data in the signals, such as, time of flight, signal strength, or other data to effect a position measurement. Also, for example, one or more accelerometers, which also form part of the manipulator apparatus 102, could be provided on the manipulator 121 to acquire inertial or directional data, in one, two, or three axes, regarding the movement thereof.

The manipulator 121 may be piloted by a human operator at the operator interface 106. In human operator controlled or piloted mode, the human operator observes representations of sensor data, for example, video, audio, or haptic data received from one or more sensors of the sensor subsystem 114. The human operator then acts, conditioned by a perception of the representation of the data, and creates information or executable control instructions to direct the manipulator 121 accordingly. In piloted mode, the manipulator apparatus 102 may execute control instructions in real-time (e.g., without added delay) as received from the operator interface 106 without taking into account other control instructions based on sensed information.

In some implementations, the manipulator apparatus 102 operates autonomously. That is, without a human operator creating control instructions at the operator interface 106 for directing the manipulator 121. The manipulator apparatus 102 may operate in an autonomous control mode by executing autonomous control instructions. For example, the controller 110 can use sensor data from one or more sensors of the sensor subsystem 114, the sensor data being associated with operator generated control instructions from one or more times the manipulator apparatus 102 was in piloted mode to generate autonomous control instructions for subsequent use. For example, by using deep learning techniques to extract features from the sensor data such that in autonomous mode the manipulator apparatus 102 autonomously recognize features or conditions in its environment and the article 132 to be manipulated, and in response perform a defined act, set of acts, a task, or a pipeline or sequence of tasks. In some implementations, the controller 110 autonomously recognises features and/or conditions in the environment surrounding the manipulator 121, as represented by a sensor data from the sensor subsystem 114 and one or more virtual articles composited into the environment, and in response to being presented with the representation, issue control signals to the manipulator apparatus 102 to perform one or more actions or tasks.

In some instances, the manipulator apparatus 102 may be controlled autonomously at one time, while being piloted, operated, or controlled by a human operator at another time. That is, operate under an autonomous control mode and change to operate under a piloted mode (i.e., non-autonomous). In another mode of operation, the manipulator apparatus 102 can replay or execute control instructions previously carried out in a human operator controlled (or piloted) mode. That is, the manipulator apparatus 102 can operate without sensor data based on replayed pilot data.

The manipulator apparatus 102 further includes a communication interface subsystem 124, e.g., a network interface device, that is communicably coupled to a bus 126 and provides bi-directional communication with other components of the system 100 (e.g., the controller 110) via the communication interface 104. The communication interface subsystem 124 may be any circuitry affecting bidirectional communication of processor-readable data, and processor-executable instructions, for instance radios (e.g., radio or microwave frequency transmitters, receivers, transceivers), communications ports and/or associated controllers. Suitable communication protocols include FTP, HTTP, Web Services, SOAP with XML, WI-FI™ compliant, BLUETOOTH™ compliant, cellular (e.g., GSM, CDMA), and the like.

The manipulator 121 is an electro-mechanical machine comprising one or more appendages, such as a robotic arm 120, and a gripper assembly or end-effector 122 mounted on an end of the robotic arm 120. The gripper assembly 122 is a device of complex design configured to interact with the environment in order to perform a number of tasks, including, for example, gripping, grasping, releasably engaging or otherwise interacting with the article 132. The manipulator apparatus 102 further includes an operation subsystem 130, communicatively coupled to the robotic arm 120 and gripper assembly 122, comprising one or more motors, solenoids, other actuators, linkages, drive-belts, pressure and vacuum sources, and the like operable to cause the robotic arm 120 and/or gripper assembly 122 to move within a range of motions and carry out a range of operations in accordance with the actuation commands or control signals issued by the controller 110. The operation subsystem 130 is communicatively coupled to the controller 110 via the bus 126.

The manipulator apparatus 102 also includes an output subsystem 128 comprising one or more output devices, such as speakers, lights, and displays that enable the manipulator apparatus 102 to send signals into the workspace in order to communicate with, for example, an operator and/or another manipulator apparatus 102.

A person of ordinary skill in the art will appreciate the components in manipulator apparatus 102 may be varied, combined, split, omitted, or the like. In some examples one or more of the communication interface subsystem 124, the output subsystem 128, and/or the motion subsystem 130 may be combined. In other examples, one or more of the subsystems (e.g., the operation subsystem 130) are split into further subsystems.

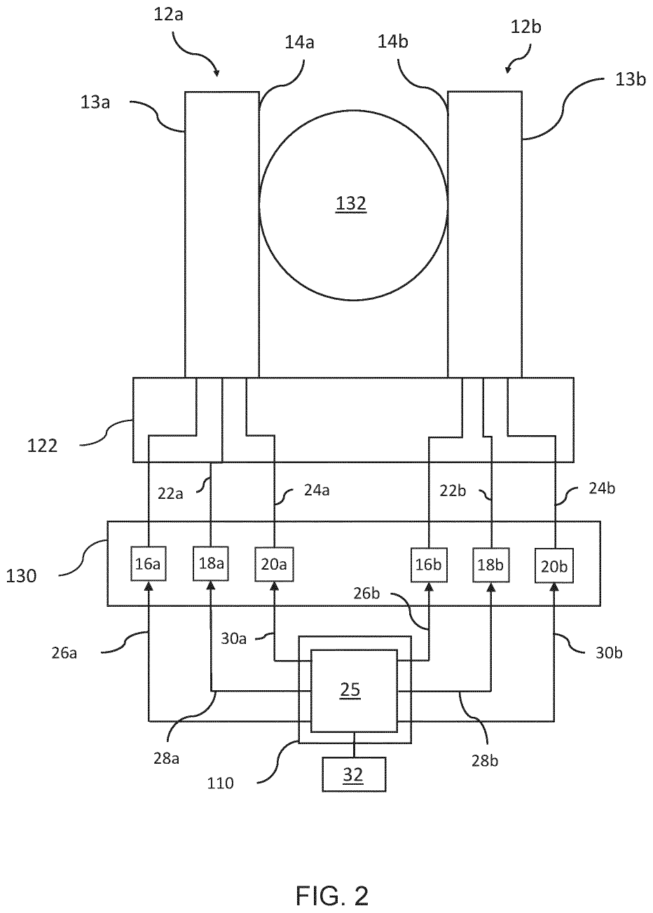

FIG. 2 shows a schematic depiction of the gripper assembly 122 according to an embodiment of the invention comprising a first finger subassembly 12a opposing a second finger subassembly 12b. Each one of the first and second finger subassemblies 12a, 12b includes a substantially rigid body 13a, 13b housing respective inflatable elements (not shown in FIG. 2). The rigid bodies 13a, 13b each comprise an exterior gripping surface 14a, 14b configured to engage the article 132. The operation subsystem 130 comprises a first actuator 16a, a first pressure source 18a and a first vacuum source 20a, all of which are associated with the first finger subassembly 12a, and a second actuator 16b, a second pressure source 18b and a second vacuum source 20b associated with the second finger subassembly 12b. The pressure and vacuum sources 18a, 18b, 20a, 20b are connected to their associated finger subassembly 12a, 12b by respective pressure lines 22a, 22b, 24a, 24b, along with other suitable connectors. As mentioned previously, the controller 110 comprises an electronic processor 25 having one or more electrical inputs for receiving an input signal from the sensor subsystem 114, such as, for example, a visual data input signal from the optical sensor 116, and one or more electrical outputs for outputting one or more control signals 26a, 26b, 28a, 28b, 30a, 30b to the actuators 16a, 16b, pressure sources 18a, 18b and vacuum sources 20a, 20b in dependence on the visual data input signals. For example, the controller 110 is configured to output a first actuation control signal 26a for moving the first finger subassembly 12a based on the visual data input signal. The first actuator 16a is configured to receive the first actuation control signal 26a and move the first finger subassembly 12a relative to the second finger subassembly 12b in dependence thereon. Similarly, the controller 110 may also output a second actuation control signal 26b for moving the second finger subassembly 12b based on the visual data input signal. The second actuator 16b is configured to receive the second actuation control signal 26b and move the second finger subassembly 12b relative to the first finger subassembly 12a in dependence on the second actuation control signal 26b. These movements may be about multiple axes of movement and include rotation of one of the first or second finger subassemblies 12a, 12b relative to the other of the first or second finger subassemblies 12a, 12b. Such movement may allow the object 132 to be gripped between the first and second finger subassemblies 12a, 12b. The first and second finger subassemblies 12a, 12b may also be movable together such that the object 132 gripped therebetween can be moved from a first location to a second location. The controller 110 is further configured to output inflation control signals 28a, 28b, in dependence on, for example, the visual data input signal to control the first or second pressure sources 18a, 18b in order to alter the pressure in the interior of the first or second finger subassemblies 12a, 12b so as to change the compliance of their respective inflatable elements. Specifically, the controller 110 is arranged to output a first inflation control signal 28a based on the visual data input signal, and the first pressure source 18a is configured to receive the first inflation control signal 28a and pressurise the first finger subassembly 12a in dependence on the first inflation control signal 28a. Similarly, the controller 110 is arranged to output a second inflation control signal 28b based on the visual data input signal, and the second pressure source 18b is configured to receive the second inflation control signal 28b and pressurise the second finger subassembly 12b in dependence thereon in order to change the compliance of its inflatable element. The controller 110 is also configured to output vacuum control signals 30a, 30b to control the first or second vacuum sources 20a, 20b in order to apply a vacuum pressure to the interior of the first or second finger subassemblies 12a, 12b. Similar to the other control signals 26a, 26b, 28a, 28b, the vacuum control signals 30a, 30b, may also be dependent on the visual data input signal, as well as other input signals received from the sensor subsystem 114. Specifically, the controller 110 is arranged to output a first vacuum control signal 30a based on the visual data input signal, and the first vacuum source 20a is configured to receive the first vacuum control signal 30a and apply a vacuum pressure to the first finger subassembly 12a in dependence thereon. The controller 110 is further arranged to output a second vacuum control signal 30b based on the visual data input signal, and the second vacuum source 20b is configured to receive the second vacuum control signal 30b and apply a vacuum pressure to the second finger subassembly 12b in dependence on the second vacuum control signal 30b. In order to generate the various control signals 26a, 26b, 28a, 28b, 30a, 30b, the controller 110 further comprises a memory device 32 electrically coupled to the electronic processor 25. The electronic processor 25 is configured to access the memory device 32 and execute the instructions stored thereon so as to carry out the foregoing processes.

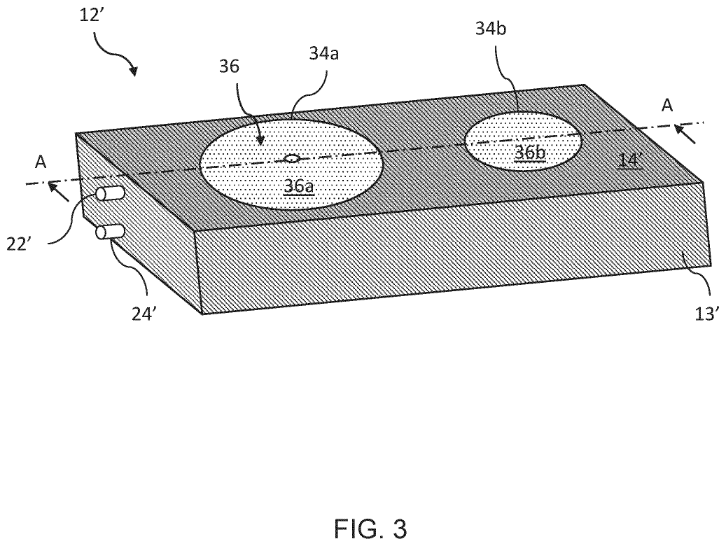

Referring to FIG. 3, which shows a schematic depiction of a perspective view of the finger subassembly 12′, the gripping surface 14′ comprises one or more apertures 34′ exposing regions of the inflatable element 36 received within the rigid body 13′. In the example shown, two apertures 34a, 34b are formed in the gripping surface 14′ such that two regions 36a, 36b of the inflatable element 36 can be seen. The material of the gripping surface 14′ has a first coefficient of friction and the material of the inflatable element 36 has a second coefficient of friction, where the second coefficient of friction is greater than the first coefficient of friction. The pressure lines 22′, 24′, connecting the pressure and vacuum sources 18′, 20′, define channels formed within the inflatable element 36 and, in this example, extend out of the base of the finger subassembly 12′.

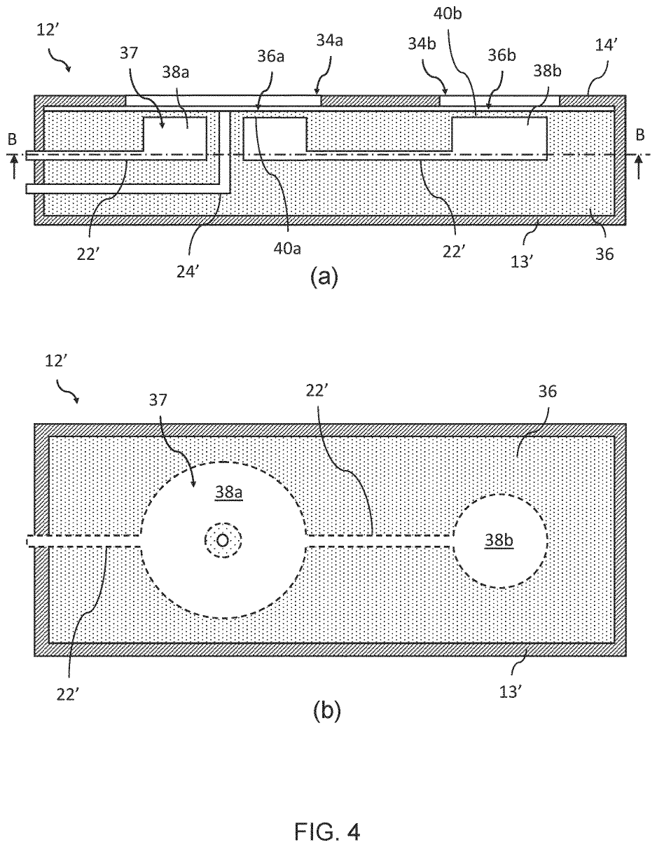

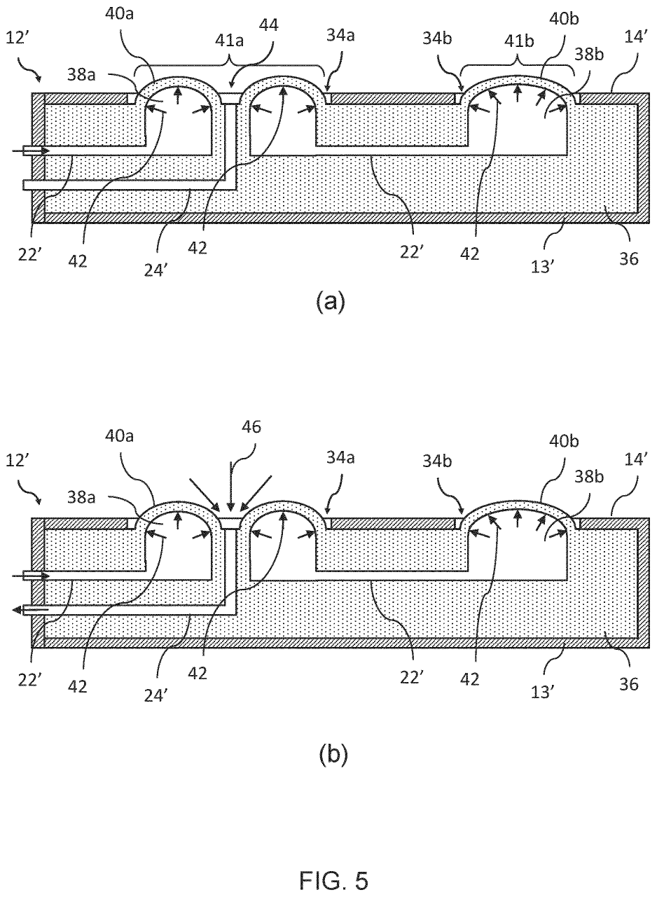

With reference to FIGS. 4a and 4b, a pressure chamber, generally designated by 37, is formed within the inflatable element 36 and connectable to the pressure source 18′ by the pressure line 22′. In this example, the pressure chamber 37 comprises two sections 38a, 38b connected by the pressure line 22′. Section 38a defines a ring-shaped void within the inflatable element 36 concentrically arranged around the pressure line 24′, whereas section 38b defines a circular void. These voids define regions 40a, 40b of the inflatable element 36 that have relatively thin cross-sections concentrically arranged within a boundary defined by the apertures 34a, 34b. It is by this arrangement that each section 38a, 38b is configured to cause the regions 40a, 40b of the inflatable element 36 to form protrusions 41a, 41b extending through respective apertures 34a, 34b when the pressure chamber 37 is pressurised by the pressure source 18′, as indicated by arrows 42 in FIG. 5a. That is, when the inflatable element 36 is in an uninflated state, it is completely received within the interior of the rigid body 13′. When the inflatable element 36 is inflated, then regions 40a, 40b of it protrude through respective apertures 34a, 34b in the gripping surface 14′, forming the plurality of protrusions 41a, 41b.

A mesh may be applied to the face of the inflatable element 36 which forms the protrusions 41a, 41b when inflated. The mesh reinforces the inflatable element 36, making it more resilient. The patterning of the mesh may also lead to a further increase in the coefficient of friction for the protrusions 41a, 41b formed when the inflatable element 36 is inflated. The mesh also reduces the amount by which the inflatable element 32 can be inflated and allows for higher pressures to be applied that, in turn, allows for higher gripping forces, and less compliance.

Therefore, in one respect, the present invention relates to a finger assembly 12′ for use in a manipulating apparatus 102. In one state, the finger assembly 12′ has a low coefficient of friction, whilst in a second state the finger assembly 12′ has a relatively higher coefficient of friction. This is achieved by locating an inflatable element 36 within a rigid body 13′ comprising one or more apertures 34a, 34b. By inflating the inflatable element 36, regions 40a, 40b of the inflatable element 36 will protrude through the one or more of apertures 34a, 34b, causing the finger assembly 12′ to have an increased coefficient of friction.

Due to the arrangement of section 38a, a suction chamber 44, in the form of a conical frustum, is defined at the centre of the ring-shaped protrusion 41a. The channel defined by pressure line 24′ extends between the region 40a of the inflatable element 36 that forms the protrusion 41a and the vacuum source 20′ to provide a vacuum pressure at the suction chamber 44, as indicated by arrows 46 in FIG. 5b, further improving the gripping force of the finger subassembly 12′. The finger subassembly 12′ may include a pressure release valve (not shown) openable to stop the vacuum pressure at the suction chamber 44.

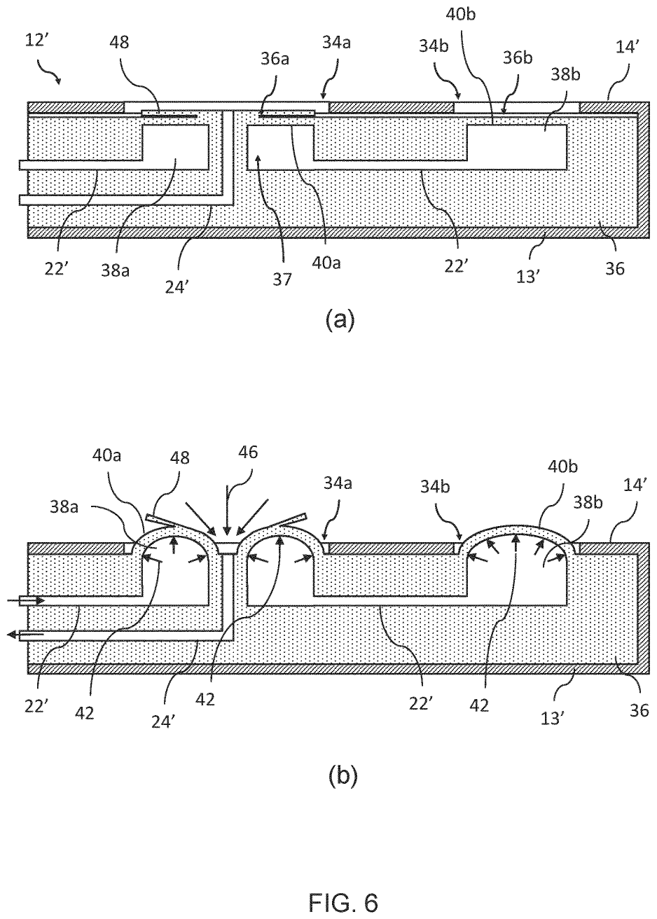

FIGS. 6a and 6b show a second embodiment of the finger subassembly 12′. This embodiment is substantially the same as the previous embodiment except that it further comprises a circular planar structure 48 extending over the region 40a of the inflatable element 36 that is configured to form the ring-shaped protrusion 41a. The planar structure 48 is configured to form a sealing lip for the suction chamber 44 when the pressure chamber 37 is pressurised, reducing the likelihood of the seal to the suction chamber 44 being broken during the manipulation of an article 132.

The foregoing description has been presented for the purpose of illustration only and is not intended to be exhaustive or to limit the invention to the precise embodiments disclosed. It will be appreciated that modifications and variations can be made to the described embodiments without departing from the scope of the invention as defined in the appended claims.

1. A finger subassembly for a manipulator apparatus, the finger subassembly comprising:
a rigid body comprising a surface configured to engage an object to be manipulated, the surface comprising an aperture;
an inflatable element received within the rigid body;
a pressure chamber formed within the inflatable element, the pressure chamber being connectable to a pressure source and comprising a first section configured to cause a region of the inflatable element to form a protrusion extending through the aperture when the pressure chamber is pressurised, wherein the protrusion is arranged to define a suction chamber; and,
a channel formed within the inflatable element, the channel being configured to extend between the region of the inflatable element that forms the protrusion when the pressure chamber is pressurised and a vacuum source to provide a vacuum pressure at the suction chamber.

2. The finger subassembly according to claim 1, wherein the inflatable element further comprises a substantially planar structure extending over the region of the inflatable element configured to form the protrusion, wherein the planar structure is configured to form a sealing lip for the suction chamber when the pressure chamber is pressurised.

3. The finger subassembly according to claim 1, wherein the first section of the pressure chamber configured to cause the region of the inflatable element to form the protrusion is positioned within a boundary defined by the aperture.

4. The finger subassembly according to claim 1, wherein the channel formed within the inflatable element connectable to the vacuum source comprises a pressure release valve.

5. The finger subassembly according to claim 1, wherein the pressure chamber is configured such that the protrusion is ring-shaped and the suction chamber defines a conical frustum.

6. The finger subassembly according to claim 1, wherein the surface of the rigid body further comprises a second aperture and the pressure chamber comprises a second section configured to cause a second region of the inflatable element to form a second protrusion extending through the second aperture when pressurised.

7. The finger subassembly according to claim 6, wherein the first and second sections of the pressure chamber are fluidically linked by a pressure line.

8. The finger subassembly according to claim 1, wherein the surface has a first coefficient of friction and the inflatable element has a second coefficient of friction which is greater than the first coefficient of friction.

9. The finger subassembly according to claim 1, wherein the inflatable element comprises a mesh.

10. The finger subassembly according to claim 9, wherein the mesh is formed on the region of the inflatable element configured to form the protrusion.

11. A manipulator apparatus comprising a finger subassembly, the finger subassembly comprising:
a rigid body comprising a surface configured to engage an object to be manipulated, the surface comprising an aperture;
an inflatable element received within the rigid body;
a pressure chamber formed within the inflatable element, the pressure chamber being connectable to a pressure source and comprising a section configured to cause a region of the inflatable element to form a protrusion extending through the aperture when the pressure chamber is pressurised, wherein the protrusion is arranged to define a suction chamber; and
a channel formed within the inflatable element, the channel being configured to extend between the region of the inflatable element that forms the protrusion when the pressure chamber is pressurised and a vacuum source to provide a vacuum pressure at the suction chamber.

12. A picking system comprising a manipulator apparatus, the manipulator apparatus comprising a finger subassembly, the finger subassembly comprising:
a rigid body comprising a surface configured to engage an object to be manipulated, the surface comprising an aperture;
an inflatable element received within the rigid body;
a pressure chamber formed within the inflatable element, the pressure chamber being connectable to a pressure source and comprising a section configured to cause a region of the inflatable element to form a protrusion extending through the aperture when the pressure chamber is pressurised, wherein the protrusion is arranged to define a suction chamber; and
a channel formed within the inflatable element, the channel being configured to extend between the region of the inflatable element that forms the protrusion when the pressure chamber is pressurised and a vacuum source to provide a vacuum pressure at the suction chamber.
